(19) United States
(12) Patent Application Publication
(10) Pub. No.: US 2026/0081978 A1
(43) Pub. Date: Mar. 19, 2026

(54) INTEROPERABILITY BETWEEN MULTICAST PROTOCOL VARIANTS

(71) Applicant: HEWLETT PACKARD ENTERPRISE DEVELOPMENT LP, Spring, TX (US)

(72) Inventors: Tathagata Nandy, Bangalore (IN); Anil Raj, Bangalore (IN); Subramanian Muthukumar, Bangalore (IN)

(21) Appl. No.: 18/966,926

(22) Filed: Dec. 3, 2024

(30) Foreign Application Priority Data
Sep. 19, 2024 (IN) 202441071071

(51) Int. Cl. H04L 69/08; H04L 69/14

(52) U.S. Cl. CPC H04L 69/08; H04L 69/14

(57) ABSTRACT

A network device in a network is provided. During operation, the network device can operate as a first rendezvous point (RP) of a Bidirectional Protocol Independent Multicast (PIM-BIDIR) instance and also as a first RP of a PIM sparse mode (PIM-SM) instance. Here, the PIM-BIDIR instance can be deployed in a first segment of the network and the PIM-SM instance can be deployed in a second segment of the network. The network device can receive information associated with a first source of a first multicast group from a second RP of the PIM-SM instance. Subsequent to receiving a first join request for the first multicast group via the PIM-BIDIR instance, the network device can send a second join request of the PIM-SM instance to the first source based on the received information and forward multicast traffic received from the first source via a multicast tree of the PIM-BIDIR instance.

### BACKGROUND

A network device, such as a switch, may be deployed in different network topologies. For example, the network device can be deployed in a network with multiple segments (e.g., different sites of an enterprise network). As a result, the network device may send and receive packets to and from these segments. These segments may run different multicast protocol variants, such as Protocol Independent Multicast (PIM) sparse-mode (PIM-SM) and bidirectional PIM (PIM-BIDIR).

### BRIEF DESCRIPTION OF THE FIGURES

FIG. 1 illustrates an example of a network sending traffic from a segment running PIM-SM to a segment running PIM-BIDIR, in accordance with an aspect of the present application.

FIG. 2 illustrates an example of a network sending traffic from a segment running PIM-BIDIR to a segment running PIM-SM, in accordance with an aspect of the present application.

FIG. 3 presents a flowchart illustrating an example of a process of a network device forwarding multicast traffic from a PIM-SM instance to a PIM-BIDIR instance, in accordance with an aspect of the present application.

FIG. 4 presents a flowchart illustrating an example of a process of a network device synchronizing source information associated with multicast groups, in accordance with an aspect of the present application.

FIG. 5 presents a flowchart illustrating an example of a process of a network device forwarding multicast traffic from a PIM-BIDIR instance to a PIM-SM instance, in accordance with an aspect of the present application.

FIG. 6 illustrates an example of a computing system facilitating efficient programming of static multicast routes in a load-balanced network, in accordance with an aspect of the present application.

FIG. 7 illustrates an example of a computer-readable medium (CRM) facilitating efficient programming of static multicast routes in a load-balanced network, in accordance with an aspect of the present application.

In the figures, like reference numerals refer to the same figure elements.

### DETAILED DESCRIPTION

In various Internet applications, multicast is frequently used to distribute content from a source to multiple hosts via one or more network devices, such as switches. Efficient distribution of multicast traffic can improve the performance of a network. A layer-3 multicast protocol, such as PIM, can be used for distributing content in a network. In some scenarios, a host can send a client join request (e.g., an Internet Group Management Protocol (IGMP) join request or a Multicast Listener Discovery (MLD) join request) to a network device, which can couple the host, to receive traffic of a multicast group. This network device can be referred to as a requesting network device.

The requesting network device can send a network join request (e.g., a PIM join request) to a source network device coupling the source of the multicast group. The source network device can then start forwarding multicast traffic from the source to the requesting network device. A network may include multiple network segments, each segment can be deployed in a site of the network (e.g., different sites of an enterprise network). One or more network devices of each segment can be coupled to an external network, such as a wide-area network (WAN), thereby coupling the segments to each other. These network devices can be referred to as border network devices. Consequently, a source and a host of a multicast group can be in different segments of the network. As a result, the traffic from the source to the host can be forwarded from one segment to another.

The aspects described herein address the problem of efficiently interoperating multicast protocol variants deployed on different segments of a network by (i) operating the border network device of a segment as respective PIM-SM and PIM-BIDIR rendezvous points (RPs); and (ii) upon receiving a join request associated with a PIM variant, generating a new join request associated with another PIM variant based on the received join request. As a result, each segment of the network can forward a join request based on the PIM variant supported by that segment. Consequently, the source network device can receive the join request and start forwarding multicast traffic toward the border network device, which can then forward the multicast traffic to the source network device.

Currently, different segments of the network may have different multicast requirements. As a result, different segments may deploy different multicast protocol variants, such as PIM-SM and PIM-BIDIR. During operation, a network device coupling a source of a multicast group can receive multicast traffic of the multicast group. Such a network device can be referred to as a source network device. The source network device can operate as the source-connected designated router (DR) or source DR, which is responsible for forwarding multicast traffic to a requesting network device. The requesting network device can operate as the client-connected DR or client DR, which is responsible for requesting multicast traffic for a multicast group. For the PIM-SM protocol, the source of a multicast group can register with the PIM-SM RP. A requesting network device can send a PIM-SM join request to the PIM-SM RP, which can then forward it to the source network device.

Subsequently, the source network device can determine, based on the PIM join request, which network device has requested data from the multicast group. The source network device can then forward the multicast traffic to the requesting network devices via the source-specific multicast tree (SPMT). Here, the SPMT includes tree branches from the source to the respective requesting network devices. A network may include multiple network segments, each comprising a set of network devices and the links coupling them. If the network segment includes a limited number of sources (e.g., few network devices, a limited number of processing resources in a network device, etc.), the network segment may deploy the PIM-SM protocol (e.g., run PIM-SM instances on the network devices) for distributing multicast traffic. In other words, a PIM-SM instance can be deployed on a respective network device of the segment. Here, the PIM-SM instance can be the PIM-SM protocol instance running on the network device. This segment can be referred to as a PIM-SM segment.

On the other hand, for PIM-BIDIR protocol, the multicast traffic of the multicast group can be distributed via a root-path multicast tree (RPMT) in the network. Since the RPMT is rooted at the PIM-BIDIR RP, the RPMT can be a source-independent multicast tree (i.e., not associated with a particular source). Instead of forwarding the multicast traffic to individual recipients, the source network device can forward the multicast traffic to the PIM-BIDIR RP via the RPMT. The PIM-BIDIR RP can then forward the multicast traffic to a respective requesting network device. Here, the PIM-BIDIR protocol can facilitate the distribution of multicast traffic without relying on the SPMT. If a network segment includes a large number of sources and hosts (e.g., video conferencing), the network segment may deploy the PIM-BIDIR protocol (e.g., run PIM-BIDIR instances on the network devices) for distributing multicast traffic. In other words, a PIM-BIDIR instance can be deployed on a respective network device of the segment. This segment can be referred to as a PIM-BIDIR segment.

Since these segments can be part of the same network, a source and a host can be in different segments. For example, a source can be coupled to the PIM-BIDIR segment while a host can be coupled to the PIM-SM segment. However, the PIM-SM and PIM-BIDIR instances may not be fully interoperable with each other. Therefore, when the requesting network device sends a PIM-SM join request toward the source, the border network device of the PIM-BIDIR segment can receive the PIM-SM join request. However, since the border network device runs a PIM-BIDIR instance, the border network device may not recognize the PIM-SM join request and discard it. As a result, the host may not receive multicast traffic from the source.

To address this issue, the PIM-BIDIR RP can be enhanced to communicate with the PIM-SM RP to establish multicast interoperability between the segments. The PIM-BIDIR RP can be deployed on the border network device (e.g., the network device that can couple the segment to an external network) of the PIM-BIDIR segment. This border network device can also be referred to as a PIM-BIDIR border network device or a PIM-BIDIR border device. Similarly, the PIM-SM RP can be deployed on the border network device of the PIM-SM segment. This border network device can also be referred to as a PIM-SM border network device or a PIM-SM border device. Since the border network devices are coupled to each other to facilitate communication between the segments, the PIM-SM RPs on the respective border devices can become network peers.

Since the PIM-BIDIR border device (i.e., the border network device of the PIM-BIDIR segment) can also be configured as a PIM-SM RP, the PIM-BIDIR border device can operate both as a PIM-BIDIR RP and a PIM-SM RP. The PIM-SM RP on the PIM-BIDIR border device can start operating as another RP in the PIM-SM segment. The PIM-SM protocol can support a Multicast Source Discovery Protocol (MSDP), which can allow multiple RPs to operate in the PIM-SM segment. The PIM-SM RPs in the network can run respective MSDP instances (i.e., the MSDP protocol instances running on network devices) for synchronizing source information (e.g., an Internet Protocol (IP) address of a source) with each other. Consequently, when the PIM-SM RP in the PIM-SM segment discovers the source, it can synchronize the source information with the PIM-SM RP in the PIM-BIDIR segment based on MSDP. In this way, the PIM-BIDIR border device becomes aware of the sources in the PIM-SM segment.

During operation, the host can send an IGMP (or MLD) join request to the requesting network device for a multicast group G. If the source is reachable via the PIM-SM segment and the host is reachable via the PIM-BIDIR segment, the requesting network device can then generate a PIM-BIDIR join request and send it via the RPMT. Since the PIM-BIDIR protocol does not use an SPMT, the PIM-BIDIR join request can be a (*, G) join request. Here, the “*” indicates that the join request is not associated with a particular source. The PIM-BIDIR RP, which can run on the PIM-BIDIR border device, can then receive the PIM-BIDIR join request via the RPMT. The PIM-BIDIR border device can then convert the PIM-BIDIR join request to a PIM-SM join request.

Since the PIM-SM RP running on the PIM-BIDIR border device can have the knowledge of source S of multicast group G, the PIM-SM join request can be an (S, G) join request. The PIM-BIDIR RP running on the PIM-BIDIR border device can then send the PIM-SM join request to the PIM-SM segment. The PIM-SM border device can then receive the PIM-SM join request and forward it to the source network device. Upon receiving the PIM-SM join request, the source network device can start sending multicast traffic of the multicast group toward the PIM-BIDIR segment. Accordingly, the PIM-BIDIR border device can receive the multicast traffic and forward it to the requesting network device via the RPMT. Subsequently, the requesting network device can forward the multicast traffic to the host.

If the host is reachable via the PIM-SM segment and the source is reachable via the PIM-BIDIR segment, the requesting network device can generate a PIM-SM join request. Since the requesting network device may not be aware of the source apriori, the PIM-SM join request can be a (*, G) join request. The requesting network device can then send the PIM-SM join request to the PIM-SM RP running on the PIM-BIDIR border device. Upon receiving the PIM-SM join request, the PIM-BIDIR border device can convert the PIM-SM join request to a PIM-BIDIR join request. Here, the PIM-BIDIR join request can be a (*, G) join request. The PIM-BIDIR RP can then send the PIM-BIDIR join request to the source network device via the RPMT.

Upon receiving the PIM-BIDIR join request, the source network device can start sending multicast traffic of the multicast group toward the PIM-BIDIR RP via the RPMT. The PIM-BIDIR border device can receive the multicast traffic and forward it to the PIM-SM segment. The PIM-SM border device can receive the multicast traffic and forward it to the requesting network device. Subsequently, the requesting network device can forward the multicast traffic to the host. Furthermore, the requesting network device can discover the source from the multicast traffic and, hence, can start sending a PIM-SM join request, which can be a (S, G) join request, toward the source. However, since the shortest path to the source can be via the PIM-BIDIR border device, the PIM-SM join request can be received by the PIM-BIDIR border device, which can then drop the PIM-SM join request since a (S, G) join request is not supported by the PIM-BIDIR protocol. In this way, the interoperability between PIM variants can be supported by the network.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch. ” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch. ” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction. ” Furthermore, the term “port” can refer to the port that can receive or transmit data. “Port” can also refer to the hardware, software, and/or firmware logic that can facilitate the operations of that port.

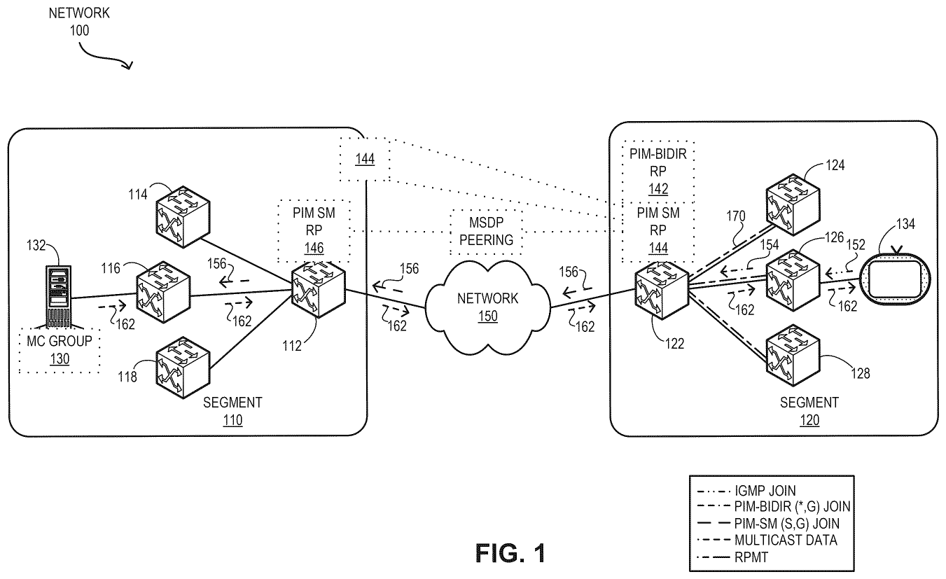

FIG. 1 illustrates an example of a network sending traffic from a segment running PIM-SM to a segment running PIM-BIDIR, in accordance with an aspect of the present application. A network 100 can include a number of network devices (e.g., switches), and may include network devices, such as layer-2 and layer-3 hops, and tunnels. In some examples, network 100 can be an Ethernet network, InfiniBand network, or other network, and may use a corresponding communication protocol, such as IP, FibreChannel over Ethernet (FCoE), or other protocols. Network 100 can include segments 110 and 120 coupled to each other via network 150 (e.g., a WAN, such as the Internet). For example, if network 100 is an enterprise network, segments 110 and 120 can correspond to respective sites or departments of the enterprise.

In this example, segment 110 can include network devices 112, 114, 116, and 118; and segment 120 can include network devices 122, 124, 126, and 128. A respective network device in network 100 can be assigned a MAC address and an IP address and can include at least one processing resource. Examples of a processing resource can include, but are not limited to, a processor core, a graphics processing unit (GPU), and a tensor processing unit (TPU). Network devices 112 and 122 can couple segments 110 and 120, respectively to network 150. Therefore, network devices 112 and 122 can operate as border network devices for segments 110 and 120, respectively. Currently, segments 110 and 120 may have different multicast requirements. As a result, different segments may deploy different multicast protocol variants. In network 100, segment 110 can distribute multicast traffic using the PIM-SM protocol, and segment 120 can distribute multicast traffic using the PIM-BIDIR. In other words, a PIM-SM instance (i.e., the PIM-SM protocol instance running on the network devices of segment 110) can be deployed on a respective network device of segment 110, and a PIM-BIDIR instance (i.e., the PIM-BIDIR protocol instance running on the network devices of segment 220) can be deployed on a respective network device of segment 120.

End devices 132 and 134 can be coupled to network devices 116 and 126, respectively. End device 132 can be the source for multicast group 130 and, hence, can be referred to as source 132. Therefore, multicast traffic 162 (e.g., a stream of multicast packets) of multicast group 130 can be sent from source 132. Network device 116, which can be the source DR, can receive multicast traffic 162 from source 132. Network device 116 can distribute multicast traffic 162 in segment 110 in accordance with the PIM-SM instance running on network device 116. On the other hand, multicast traffic and join requests in segment 120 can be distributed using an RPMT 170 rooted at PIM-BIDIR RP 142. For example, a respective network device in segment 120 can forward a join request for multicast group 130 toward PIM-BIDIR RP 142 over RPMT 170. On the other hand, upon receiving the multicast traffic of multicast group 130, PIM-BIDIR RP 142 can distribute the multicast traffic over RPMT 170. In segment 120, network device 122 can operate as PIM-BIDIR RP 142. If end device 134 requests traffic for multicast group 130, end device 134 can send an IGMP (or MLD) join request 152 to network device 126, which can be the client DR. Therefore, end device 134 can also be referred to as a requesting host 134 (or host 134).

Network device 126 can then send a PIM-BIDIR join request 154 (e.g., a (*, G) join request) to network device 122 via RPMT 170. However, since network device 116 is not on RPMT 170, network device 126 may not be able to send join request 154 to network device 116. Even if join request 154 is sent to segment 110, the PIM-SM instance on network device 112 may not recognize join request 154. Similarly, if a join PIM-SM request is sent from segment 110 to network device 122, the PIM-BIDIR instance running on network device 122 may not recognize the PIM-SM join request and discard it. As a result, if the source and host of a multicast group are in different segments, the host may not receive multicast traffic from the source.

To address this issue, network device 122 can operate as a PIM-SM RP 144 in addition to PIM-BIDIR RP 142. Border network device 122 of segment 120 operating as PIM-BIDIR RP 142 and PIM-SM RP 144 can establish multicast interoperability between segments 110 and 120. Furthermore, border network device 112 of segment 110 can operate as PIM-SM RP 146. Since network devices 112 and 122 are coupled to network 150 to facilitate communication between segments 110 and 120, PIM-SM RPs 144 and 146 can become network peers. Since network device 122 can operate as PIM-SM RP 144, network device 122 can start operating as another RP for the PIM-SM instances running in segment 110 (e.g., via network 150).

The PIM-SM protocol can support MSDP, which can allow multiple RPs to operate in segment 110. Therefore, PIM-SM RPs 144 and 146 can run respective MSDP instances and establish MSDP peering (e.g., exchanging information based on MSDP) between them. Based on the MSDP peering, PIM-SM RPs 144 and 146 can synchronize source information with each other. Consequently, when PIM-SM RP 146 discovers source 116 based on source information received from source 116 (e.g., the IP address of source 116 and multicast group 130), PIM-SM RP 146 can synchronize the source information with PIM-SM RP 144 based on MSDP. In this way, network device 122 becomes aware of source 116.

When host 134 sends join request 152 to network device 126 for a multicast group 130, network device 126 can send join request 154 to PIM-BIDIR RP 142 via RPMT 170. Network device 122 can then receive join request 154 and determine which source is associated with multicast group 130. Based on the routing protocol running on network device 122, such as Border Gateway Protocol (BGP), network device 122 can determine that source 132 is reachable via segment 110. Since segment 110 distributes traffic based on the PIM-SM protocol, network device 122 can convert join request 154 to a PIM-SM join request 156. Join request 156 can be a (S, G) join request. Here, S corresponds to source 132, and G corresponds to multicast group 130.

Network device 122 can then forward join request 156 to segment 110 via network 150. Network device 112, which can be the border network device of segment 110, can receive join request 156 and forward it toward source 132. Source 132 can start sending multicast traffic 162 to network device 116. When network device 116 receives join request 156, network device 116 can start sending multicast traffic 162 toward network device 126. Based on the routing protocol running on network device 116, such as BGP, network device 116 can determine that network device 126 is reachable via segment 120. For example, the BGP instance running on network device 116 can determine that the subnet associated with network device 126 corresponds to an external segment where the next-hop device is border network device 112. Accordingly, network device 116 can send multicast traffic 162 to network device 112, which can then forward multicast traffic 162 to network device 122. When network device 122 receive multicast traffic 162, PIM-BIDIR RP 142 on network device 122 can forward multicast traffic 162 to network device 126 via RPMT 170. Network device 126 can then forward multicast traffic 162 to host 134. In this way, even when source 132 is reachable via PIM-SM and host 134 is reachable via PIM-BIDIR, host 134 can request multicast traffic from source 132, and source 132 can forward multicast traffic to host 134.

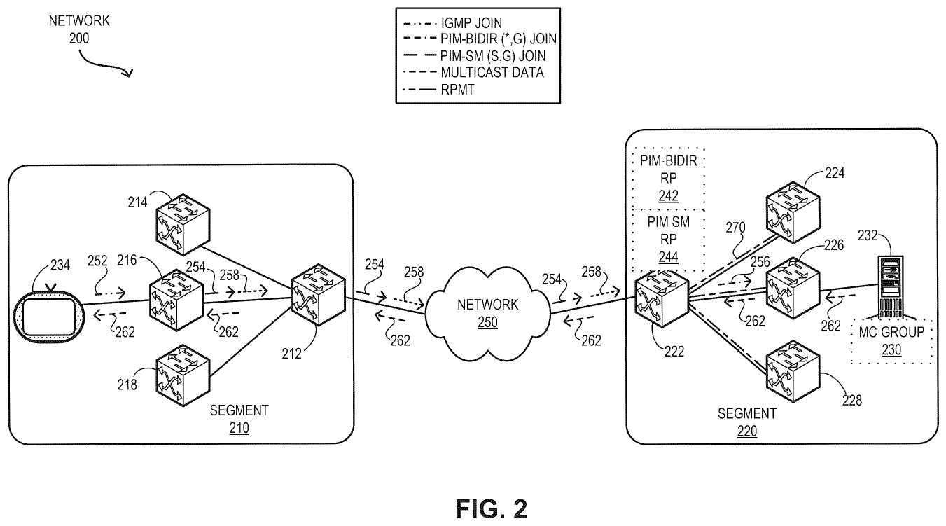

FIG. 2 illustrates an example of a network sending traffic from a segment running PIM-BIDIR to a segment running PIM-SM, in accordance with an aspect of the present application. A network 200 can include a number of network devices (e.g., switches), and may include network devices, such as layer-2 and layer-3 hops, and tunnels. In some examples, network 200 can be an Ethernet network, InfiniBand network, or other network, and may use a corresponding communication protocol, such as IP, FibreChannel over Ethernet FCoE, or other protocols. Network 200 can include segments 210 and 220 coupled to each other via network 250 (e.g., a WAN, such as the Internet). For example, if network 200 is an enterprise network, segments 210 and 220 can correspond to respective sites or departments of the enterprise.

In this example, segment 210 can include network devices 212, 214, 216, and 218; and segment 220 can include network devices 222, 224, 226, and 228. A respective network device in network 200 can be associated with a MAC address and an IP address and can include at least one processing resource. Examples of a processing resource can include, but are not limited to, a processor core, a GPU, and a TPU. Network devices 212 and 222 can couple segments 210 and 220, respectively, to network 250. Therefore, network devices 212 and 222 can operate as border network devices for segments 210 and 220, respectively. Currently, segments 210 and 220 may have different multicast requirements. As a result, different segments may deploy different multicast protocol variants. In network 200, segment 210 can distribute multicast traffic using the PIM-SM protocol, and segment 220 can distribute multicast traffic using the PIM-BIDIR. In other words, a PIM-SM instance (i.e., the PIM-SM protocol instance running on the network devices of segment 210) can be deployed on a respective network device of segment 210, and a PIM-BIDIR instance (i.e., the PIM-BIDIR protocol instance running on the network devices of segment 220) can be deployed on a respective network device of segment 220.

End devices 232 and 234 can be coupled to network devices 226 and 216, respectively. End device 232 can be the source for multicast group 230 and, hence, can be referred to as source 232. Therefore, multicast traffic 262 (e.g., a stream of multicast packets) of multicast group 230 can be sent from source 232. Network device 226, which can be the source DR, can receive multicast traffic 262 from source 232. Multicast traffic 262 can be distributed in segment 220 using RPMT 270 rooted at PIM-BIDIR RP 242. For example, a respective network device in segment 220 can forward a join request for multicast group 230 toward PIM-BIDIR RP 242 over RPMT 270. On the other hand, upon receiving the multicast traffic of multicast group 230, PIM-BIDIR RP 242 can distribute the multicast traffic over RPMT 270. In segment 210, network device 222 can operate as PIM-BIDIR RP 242. If end device 234 requests traffic for multicast group 230, end device 234 can send an IGMP (or MLD) join request 252 to network device 216, which can be the client DR. Therefore, end device 234 can also be referred to as a requesting host 234 (or host 234).

To facilitate interoperability between the PIM-SM and PIM-BIDIR instances, network device 222 can operate as both PIM-BIDIR RP 242 and PIM-SM RP 244. Border network device 222 operating as PIM-BIDIR RP 242 and PIM-SM RP 244 of segment 220 can establish multicast interoperability between segments 210 and 220. Upon receiving join request 252, network device 216 can send a PIM-SM join request 254 (e.g., a (*, G) join request) to PIM-SM RP 244. Since network device 222 runs PIM-SM RP 244, network device 216 can send join request 254 toward network device 222. Network device 212 can receive join request 254 and forward it to network device 222 via network 250. Network device 222 can then receive join request 254 and determine that source 232 is reachable via network device 226. Since segment 220 distributes traffic based on the PIM-BIDIR protocol, network device 222 can convert join request 154 to a PIM-BIDIR join request 256. Join request 256 can be a (*, G) join request corresponding to multicast group 130. Network device 222 can then send join request 256 to network device 226 via RPMT 270.

Source 232 can start sending multicast traffic 262 to network device 226. Upon receiving join request 256, network device 226 can start sending multicast traffic 262 of multicast group 230 toward PIM-BIDIR RP 242 via RPMT 270. Network device 222 can receive multicast traffic 262 and forward it to segment 210. Network device 212 can receive multicast traffic 262 and forward it to network device 216 in accordance with the PIM-SM instance running on network device 212. Subsequently, network device 216 can forward multicast traffic 262 to host 234. In this way, even when source 232 is reachable via PIM-BIDIR and host 234 is reachable via PIM-SM, host 234 can request multicast traffic from source 232, and source 232 can forward multicast traffic to host 234.

Furthermore, network device 216 can discover source 232 from multicast traffic 262 (e.g., from the source IP address indicated in multicast traffic 262). Based on the PIM-SM instance running on network device 216, network device 216 can start sending a PIM-SM join request 258, which can be a (S, G) join request, toward source 232. Here, S can correspond to source 232, and G can correspond to multicast group 230. In network 200, the shortest path to source 232 can be via network device 232.

Hence, join request 258 can be received by network device 222. A PIM-SM (S, G) join request is not supported by the PIM-BIDIR protocol. Accordingly, network device 222 can drop join request 258. As a result, the PIM-SM instance on network device 216 can continue to operate without modification. In this way, the PIM variants of segments 210 and 220 can interoperate without modifying the protocol instances on individual network devices.

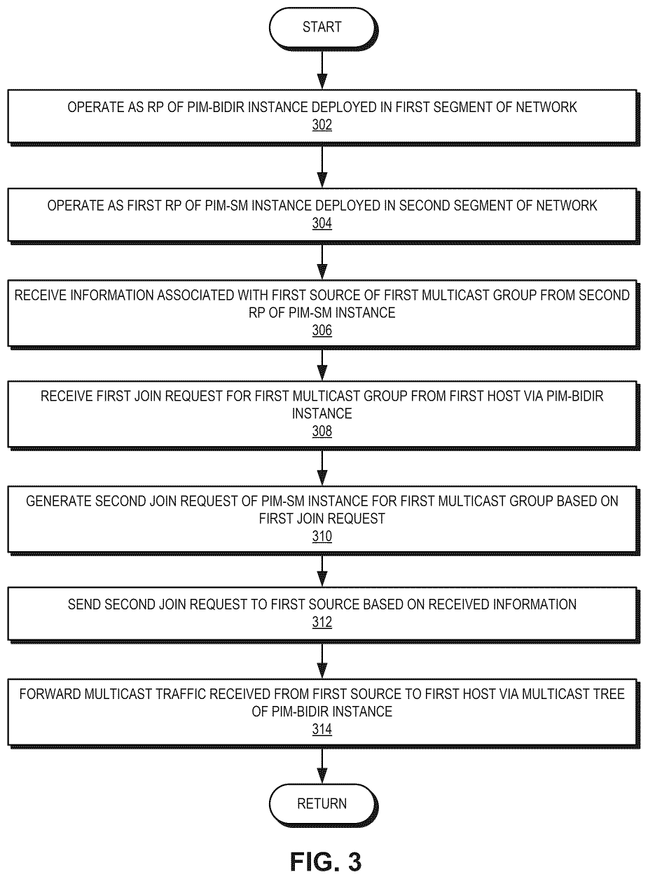

FIG. 3 presents a flowchart illustrating an example of a process of a network device forwarding multicast traffic from a PIM-SM instance to a PIM-BIDIR instance, in accordance with an aspect of the present application. During operation, the network device can as a RP of the PIM-BIDIR instance deployed in the first segment of the network (operation 302). Deploying the PIM-BIDIR instance in the first segment can include running the PIM-BIDIR instance on a respective network device of the first segment. Hence, multicast traffic can be distributed based on the PIM-BIDIR protocol in the first segment. The network device can operate as a first RP of the PIM-SM instance deployed in the second segment of the network (operation 304). Deploying the PIM-SM instance in the second segment can include running the PIM-SM instance on a respective network device of the second segment. Hence, multicast traffic can be distributed based on the PIM-SM protocol in the second segment. In the example in FIG. 1, the first and second segments can correspond to segments 120 and 110, respectively, of network 100. Accordingly, the RP of the PIM-BIDIR instance can be PIM-BIDIR RP 142, and the first RP of the PIM-SM instance can be PIM-SM RP 144.

The network device can receive information associated with a first source of the first multicast group from a second RP of the PIM-SM instance (operation 306). The second RP can operate as a PIM-SM RP in the second segment. In the example in FIG. 1, the second RP can be PIM-SM RP 146. PIM-SM RPs 144 and 146 can be MSDP peers. When PIM-SM RP 146 discovers source information associated with source 132, PIM-SM RP 146 can share the source information with PIM-SM RP 144 based on MSDP. The network device can then receive a first join request for the first multicast group via the PIM-BIDIR instance (operation 308).

The first join request can be a PIM-BIDIR join request (e.g., a (*, G) join request) for the multicast group (e.g., join request 154 for multicast group 130 in FIG. 1). The network device can generate a second join request of the PIM-SM instance for the first multicast group based on the first join request (operation 310). Since the network device can operate as a PIM-SM RP, the network device can generate a PIM-SM join request based on the multicast group. In the example in FIG. 1, network device 122 can generate join request 156 for multicast group 130. Here, network device 122 can convert PIM-BIDIR join request 154 into PIM-SM join request 156, both of which can be associated with multicast group 130.

Subsequently, the network device can send the second join request to the first source based on the received information (operation 312). Based on the information received from the second RP, the network device can have knowledge of the first source. Accordingly, the network device can send the second join request to the first source. Based on the second join request, the source network device coupling the first source can start sending traffic toward the requesting network device. Since the network device can be the border network device of the first segment (e.g., network device 122 in FIG. 1), the network device can receive the traffic from the source. The network device can then forward the multicast traffic from the first source via the multicast tree for the PIM-BIDIR instance (operation 314). Here, the multicast tree can be an RPMT. In the example in FIG. 1, network device 122 can receive multicast traffic 162 and forward it toward network device 126 via RPMT 170.

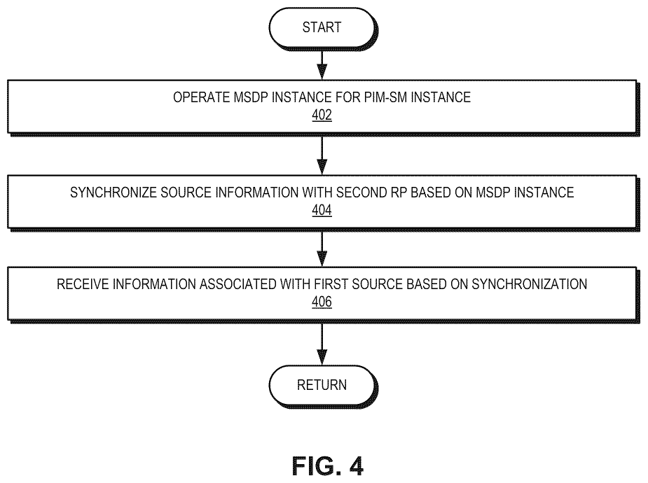

FIG. 4 presents a flowchart illustrating an example of a process of a network device synchronizing source information associated with multicast groups, in accordance with an aspect of the present application. During operation, the network device can operate an MSDP instance for the PIM-SM instance (e.g., the PIM-SM instance of FIG. 3) (operation 402). The MSDP instance allows the network device to synchronize source information of other RPs associated with the PIM-SM instance. Accordingly, the network device can synchronize the source information with the second RP based on the MSDP instance (operation 404). In the example in FIG. 1, network device 122, operating as PIM-SM RP 144, can synchronize source information with network device 112, operating as PIM-SM RP 146. Subsequently, the network device can receive information associated with the first source based on the synchronization (operation 406). For example, network device 122 can receive the source information associated with source 132 (e.g., the IP address of source 132) from network device 112.

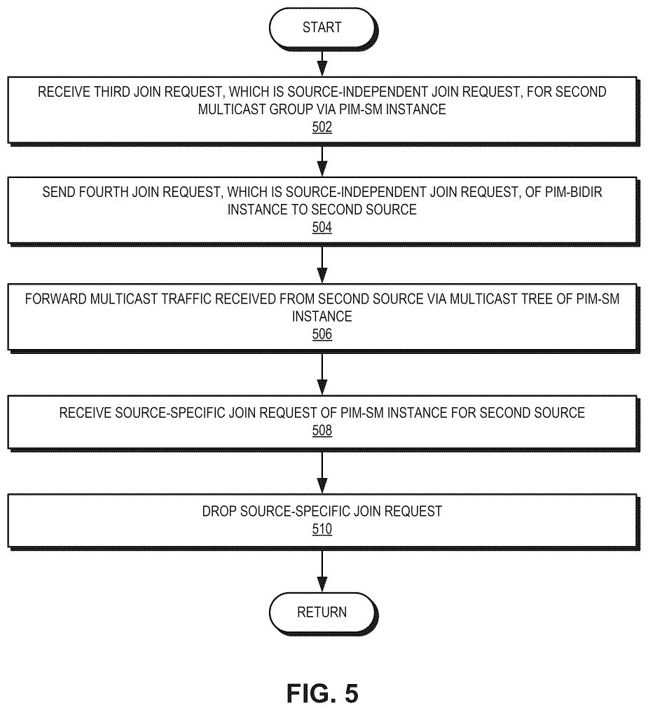

FIG. 5 presents a flowchart illustrating an example of a process of a network device forwarding multicast traffic from a PIM-BIDIR instance to a PIM-SM instance, in accordance with an aspect of the present application. During operation, the network device can receive a third join request, which can be a source-independent join request, for a second multicast group via the PIM-SM instance (operation 502). The third join request can be sent from a requesting network device coupling a host. Since the third join request is a source-independent request (e.g., a PIM-SM (*, G) join request), the third join request can be forwarded to the network device operating as the PIM-SM RP. In the example in FIG. 2, network device 222 can receive join request 254 for multicast group 230.

The network device can then send a fourth join request, which can be a source-independent join request, of the PIM-BIDIR instance to the second source (operation 504). The second source can be associated with the second multicast group. The network device can generate the fourth join request (e.g., a PIM-BIDIR (*, G) join request) based on the third join request. In the example in FIG. 2, network device 222 can generate join request 256 based on join request 254 and send it to source 232. The network device can forward the multicast traffic received from the second source via the multicast tree of the PIM-SM instance (operation 506). The network device can send the multicast traffic toward the requesting network device. Network device 222 of FIG. 2 can forward multicast traffic 262 via the multicast tree of segment 210.

The network device can also receive a source-specific join request of the PIM-SM instance for the second source (operation 508). When the requesting networking device learns the source information of the second multicast group (e.g., the IP address of the second source). In accordance with the PIM-SM protocol, the requesting networking device can send the source-specific join request (e.g., an (S, G) join request) toward the network device. Here, the network device can operate as a PIM-BIDIR RP (i.e., the network device of FIG. 3). Since the PIM-BIDIR protocol does not recognize a source-specific join request, the network device can drop the source-specific join request (operation 510). For example, network device 216 can send a source-specific join request 258 to network device 222. Here, network device 222 can operate as a PIM-BIDIR RP. Since the PIM-BIDIR instance of segment 220 does not recognize join request 258, network device 222 can drop join request 258.

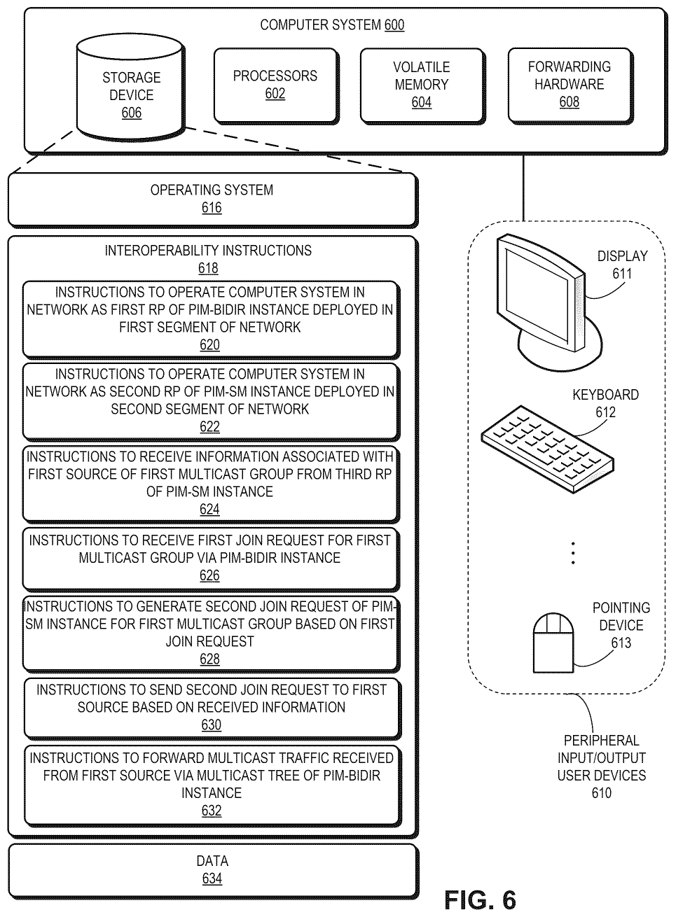

FIG. 6 illustrates an example of a computing system facilitating efficient programming of static multicast routes in a load-balanced network, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a Ternary Content Addressable Memory (TCAM). Storage device 606 includes a non-transitory computer-readable storage medium and stores an operating system 616, interoperability instructions 618, and data 634. Computer system 600 may include fewer or more entities or instructions than those shown in FIG. 6.

Interoperability instructions 618 can include instructions, which when executed by computer system 600, can cause computer system 600 to perform methods and/or processes described in this disclosure. Computer system 600 can be a network device, such as network devices 122 and 222 in FIGS. 1 and 2, respectively. Specifically, interoperability instructions 618 may include instructions 620 to operate computer system 600 in a network as an RP of the PIM-BIDIR instance deployed in a first segment of the network. Interoperability instructions 618 may also include instructions 622 to operate computer system 600 in the network as a first RP of a PIM-SM instance deployed in the second segment of the network. In the example in FIG. 1, network device 122 can operate as a PIM-BIDIR RP 142 and PIM-BIDIR RP 144.

Furthermore, interoperability instructions 618 may also include instructions 624 to receive information associated with a first source of the first multicast group from a second RP of the PIM-SM instance. In the example in FIG. 1, network device 122 can receive information of source 132 of multicast group 130 from PIM-SM RP 146. Interoperability instructions 618 may include instructions 626 to receive a first join request for the first multicast group via the PIM-BIDIR instance (e.g., network device 122 of FIG. 1 receiving join request 154). Moreover, interoperability instructions 618 may include instructions 628 to generate a second join request of the PIM-SM instance for the first multicast group based on the first join request. Here, computer system 600 can convert the first join request to the second join request. In the example in FIG. 1, network device 122 can generate join request 156 based on join request 154.

Furthermore, interoperability instructions 618 may also include instructions 630 to send the second join request to the first source based on the received information (e.g., network device 122 of FIG. 1 sending join request 156 to source 132). Interoperability instructions 618 may also include instructions 632 to forward the multicast traffic received from the first source via the multicast tree of the PIM-BIDIR instance. In the example in FIG. 1, network device 122 can forward multicast traffic 162 from source 132.

Data 634 can include any data that is required as input, or that is generated as output by the methods, operations, communications, and/or processes described in this disclosure. Specifically, data 634 can include source information associated with a respective source. Data 634 can also include information identifying a respective PIM-SM RP and a respective PIM-BIDIR RP in a network.

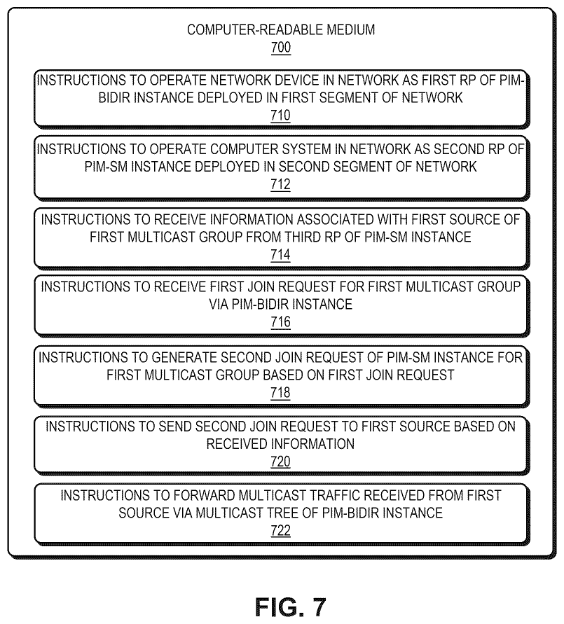

Computer system 600 and interoperability instructions 618 may include more instructions than those shown in FIG. 6. For example, interoperability instructions 618 can also store instructions for using MSDP-based synchronization between PIM-SM RPs 144 and 146 of FIG. 1; receiving, at network device 222 of FIG. 2, a source-specific join request 258 from network device 216; the operations depicted in the flowcharts of FIGS. 3, 4, and 5; and the instructions of non-transitory CRM 700 in FIG. 7.

FIG. 7 illustrates an example of a CRM facilitating efficient programming of static multicast routes in a load-balanced network, in accordance with an aspect of the present application. CRM 700 can include one or more non-transitory computer-readable mediums or devices storing instructions that when executed by a computer or processor cause the computer or processor to perform a method. Therefore, the instructions in CRM 700 can be stored in one or more non-transitory computer-readable mediums or devices. CRM 700 can store instructions 710 to operate a network device in a network as an RP of the PIM-BIDIR instance deployed in a first segment of the network. CRM 700 can also include instructions 712 to operate the network device in the network as a first RP of a PIM-SM instance deployed in the second segment of the network. In the example in FIG. 1, network device 122 can operate as a PIM-BIDIR RP 142 and PIM-BIDIR RP 144.

CRM 700 can include instructions 714 to receive information associated with a first source of the first multicast group from a second RP of the PIM-SM instance. In the example in FIG. 1, network device 122 can receive information of source 132 of multicast group 130 from PIM-SM RP 146. CRM 700 can additionally include instructions 716 to receive a first join request for the first multicast group via the PIM-BIDIR instance (e.g., network device 122 of FIG. 1 receiving join request 154). CRM 700 can further include instructions 718 to generate a second join request of the PIM-SM instance for the first multicast group based on the first join request. Here, the network device can convert the first join request to the second join request. In the example in FIG. 1, network device 122 can generate join request 156 based on join request 154.

Moreover, CRM 700 can include instructions 720 to send the second join request to the first source based on the received information (e.g., network device 122 of FIG. 1 sending join request 156 to source 132). CRM 700 can also include instructions 722 to forward the multicast traffic received from the first source via the multicast tree of the PIM-BIDIR instance. In the example in FIG. 1, network device 122 can forward multicast traffic 162 from source 132.

CRM 700 may include more instructions than those shown in FIG. 7. For example, CRM 700 can also store instructions for using MSDP-based synchronization between PIM-SM RPs 144 and 146 of FIG. 1; receiving, at network device 222 of FIG. 2, a source-specific join request 258 from network device 216; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device in a network. During operation, the network device can operate as an RP of a PIM-BIDIR instance and also as a first RP of a PIM-SM instance. Here, the PIM-BIDIR instance can be deployed in a first segment of the network and the PIM-SM instance can be deployed in a second segment of the network. The network device can receive information associated with a first source of a first multicast group from a second RP of the PIM-SM instance. Subsequent to receiving a first join request for the first multicast group via the PIM-BIDIR instance, the network device can send a second join request of the PIM-SM instance to the first source based on the received information and forward multicast traffic received from the first source via a multicast tree of the PIM-BIDIR instance.

In a variation on this aspect, the network device can operate an MSDP instance for the PIM-SM instance and synchronize source information with the second RP of the PIM-SM instance.

In a further variation, the information associated with the first source is received based on the synchronization.

In a variation on this aspect, the first join request can be a source-independent join request of the PIM-BIDIR instance. Here, the second join request is a source-specific join request of the PIM-SM instance for the first source.

In a variation on this aspect, the network device can generate the second join request for the first multicast group based on the first join request.

In a variation on this aspect, the network device can receive a third join request for a second multicast group via the PIM-SM instance. The network device can then send a fourth join request of the PIM-BIDIR instance to a second source. Subsequently, the network device can forward multicast traffic received from the second source via a multicast tree of the PIM-SM instance.

In a further variation, the network device can receive the multicast traffic received from the second source via a RPMT associated with the second multicast group.

In a further variation, the third and fourth join requests can be source-independent join requests of the PIM-SM instance and the PIM-BIDIR instance, respectively.

In a further variation, the network device can receive a source-specific join request of the PIM-SM instance for the second source and drop the source-specific join request.

In a variation on this aspect, the network device can be a first border network device of the first network segment coupling a second border network device of the second network segment. Here, the second border network device can operate the first RP of the PIM-SM instance.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
operating a network device in a network as a rendezvous point (RP) of a Bidirectional Protocol Independent Multicast (PIM-BIDIR) instance and also as a first RP of a PIM sparse mode (PIM-SM) instance, wherein the PIM-BIDIR instance is deployed in a first segment of the network and the PIM-SM instance is deployed in a second segment of the network;
receiving information associated with a first source of a first multicast group from a second RP of the PIM-SM instance;
subsequent to receiving a first join request for the first multicast group via the PIM-BIDIR instance:
sending a second join request of the PIM-SM instance to the first source based on the received information; and
forwarding multicast traffic received from the first source via a multicast tree of the PIM-BIDIR instance.

2. The method of claim 1, further comprising:
operating a Multicast Source Discovery Protocol (MSDP) instance for the PIM-SM instance; and
synchronizing source information with the second RP of the PIM-SM instance.

3. The method of claim 2, wherein the information associated with the first source is received based on the synchronization.

4. The method of claim 1,
wherein the first join request is a source-independent join request of the PIM-BIDIR instance; and
wherein the second join request is a source-specific join request of the PIM-SM instance for the first source.

5. The method of claim 1, further comprising generating the second join request for the first multicast group based on the first join request.

6. The method of claim 1, further comprising:
receiving a third join request for a second multicast group via the PIM-SM instance;
sending a fourth join request of the PIM-BIDIR instance to a second source; and
forwarding multicast traffic received from the second source via a multicast tree of the PIM-SM instance.

7. The method of claim 6, further comprising receiving the multicast traffic received from the second source via a root-path multicast tree (RPMT) associated with the second multicast group.

8. The method of claim 6, wherein the third and fourth join requests are source-independent join requests of the PIM-SM instance and the PIM-BIDIR instance, respectively.

9. The method of claim 6, further comprising:
receiving a source-specific join request of the PIM-SM instance for the second source; and
dropping the source-specific join request.

10. The method of claim 1,
wherein the network device is a first border network device of the first network segment coupling a second border network device of the second network segment; and
wherein the second border network device operates the first RP of the PIM-SM instance.

11. A non-transitory computer-readable storage medium storing instructions to:
operate a network device in a network as a first rendezvous point (RP) of a Bidirectional Protocol Independent Multicast (PIM-BIDIR) instance and also as a first RP of a PIM sparse mode (PIM-SM) instance, wherein the PIM-BIDIR instance is deployed in a first segment of the network and the PIM-SM instance is deployed in a second segment of the network;
receive information associated with a first source of a first multicast group from a second RP of the PIM-SM instance;
subsequent to receiving a first join request for the first multicast group via the PIM-BIDIR instance:
send a second join request of the PIM-SM instance to the first source based on the received information; and
forward multicast traffic received from the first source via a multicast tree of the PIM-BIDIR instance.

12. The non-transitory computer-readable storage medium of claim 11, wherein the instructions are further to:
operate a Multicast Source Discovery Protocol (MSDP) instance for the PIM-SM instance; and
synchronize source information with the second RP of the PIM-SM instance, wherein the information associated with the first source is received based on the synchronization.

13. The non-transitory computer-readable storage medium of claim 11,
wherein the first join request is a source-independent join request of the PIM-BIDIR instance; and
wherein the second join request is a source-specific join request of the PIM-SM instance for the first source.

14. The non-transitory computer-readable storage medium of claim 11, wherein the instructions are further to generate the second join request for the first multicast group based on the first join request.

15. The non-transitory computer-readable storage medium of claim 11, wherein the instructions are further to:
receive a third join request for a second multicast group via the PIM-SM instance;
send a fourth join request of the PIM-BIDIR instance to a second source; and
forward multicast traffic received from the second source via a multicast tree of the PIM-SM instance.

16. The non-transitory computer-readable storage medium of claim 15, wherein the instructions are further to receive the multicast traffic received from the second source via a root-path multicast tree (RPMT) associated with the second multicast group.

17. The non-transitory computer-readable storage medium of claim 15, wherein the third and fourth join requests are source-independent join requests of the PIM-SM instance and the PIM-BIDIR instance, respectively.

18. The non-transitory computer-readable storage medium of claim 15, wherein the instructions are further to:
receive a source-specific join request of the PIM-SM instance for the second source; and
drop the source-specific join request.

19. The non-transitory computer-readable storage medium of claim 11,
wherein the network device is a first border network device of the first network segment coupling a second border network device of the second network segment; and
wherein the second border network device operates the first RP of the PIM-SM instance.

20. A computer system, comprising:
one or more processing resources; and
a non-transitory computer-readable storage medium storing instructions that when executed by the one or more processing resources cause the computer system to:
operate the computer system in a network as a first rendezvous point (RP) of a Bidirectional Protocol Independent Multicast (PIM-BIDIR) instance and also as a first RP of a PIM sparse mode (PIM-SM) instance, wherein the PIM-BIDIR instance is deployed in a first segment of the network and the PIM-SM instance is deployed in a second segment of the network;
receive information associated with a first source of a first multicast group from a second RP of the PIM-SM instance;
subsequent to receiving a first join request for the first multicast group via the PIM-BIDIR instance:
send a second join request of the PIM-SM instance to the first source based on the received information; and
forward multicast traffic received from the first source via a multicast tree of the PIM-BIDIR instance.
